(19) United States
(12) Patent Application Publication
(10) Pub. No.: US 2020/0307552 A1
(43) Pub. Date: Oct. 1, 2020

(54) TRAVELING CONTROL DEVICE

(71) Applicant: AISIN SEIKI KABUSHIKI KAISHA, Kariya-shi (JP)

(72) Inventors: Yoshiki MURAMATSU, Kariya-shi (JP); Yosuke HASHIMOTO, Kariya-shi (JP)

(73) Assignee: AISIN SEIKI KABUSHIKI KAISHA, Kariya-shi (JP)

(21) Appl. No.: 16/816,356

(22) Filed: Mar. 12, 2020

(30) Foreign Application Priority Data
Mar. 28, 2019 (JP) 2019-063765

(51) Int. Cl. B60W 30/02; B60W 10/20; B60W 40/114

(52) U.S. Cl. CPC B60W 30/025; B60W 10/20; B60W 40/114; B60W 2710/18; B60W 2720/14; B60W 2540/18; B60W 2710/207; B60W 2520/14

(57) ABSTRACT

A traveling control device includes: a sensor information acquisition unit configured to acquire an output value of an in-vehicle sensor including a yaw rate sensor detecting an actual value of a yaw rate generated in the vehicle; a command value determination unit configured to determine a target value of the yaw rate to be generated in the vehicle based on the output value and determine a command value to be given to an actuator controlling a behavior of the vehicle such that a difference between the actual value and the target value is reduced; a characteristic parameter acquisition unit configured to acquire a characteristic parameter indicating a characteristic of a drivers driving operation based on the difference; and an adjustment output unit configured to adjust the command value according to the characteristic parameter and output the adjusted command value to the actuator.

### CROSS REFERENCE TO RELATED APPLICATIONS

This application is based on and claims priority under 35 U.S.C. §119 to Japanese Patent Application 2019-063765, filed on Mar. 28, 2019, the entire contents of which are incorporated herein by reference.

### TECHNICAL FIELD

This disclosure relates to a traveling control device.

### BACKGROUND DISCUSSION

In the related art, studies have been made on a technology to reduce a sense of discomfort given to a driver at the time of execution of stabilization control by suppressing the incompatibility between the behavior of a vehicle that is automatically realized by stabilization control that stabilizes the behavior of the vehicle and the behavior of the vehicle that is manually realized by a drivers driving operation. As such a technology, there has been known a technology to correct a target route set as a route on which a vehicle needs to travel according to the drivers intention estimated based on a drivers driving operation and to execute stabilization control along the corrected target route (see, e.g., WO 2011/080830 (Reference 1)).

However, since the above-described technology is based on the assumption that the vehicle has a configuration for calculating the target route, a vehicle with a simple configuration having no component for calculating the target route is not able to realize the technology.

Thus, a need exists for a traveling control device which is not susceptible to the drawback mentioned above.

### SUMMARY

A traveling control device as an example according to an aspect of this disclosure includes a sensor information acquisition unit configured to acquire an output value of an in-vehicle sensor that detects information regarding a vehicle and includes at least a yaw rate sensor that detects an actual value of a yaw rate generated in the vehicle, a command value determination unit configured to determine a target value of at least the yaw rate to be generated in the vehicle based on the output value of the in-vehicle sensor and determine a command value to be given to an actuator that controls a behavior of the vehicle such that a difference between the actual value and the target value of at least the yaw rate is reduced, a characteristic parameter acquisition unit configured to acquire a characteristic parameter indicating a characteristic of a drivers driving operation of the vehicle based on the difference between the actual value and the target value of at least the yaw rate, and an adjustment output unit configured to adjust the command value according to the characteristic parameter and output the adjusted command value to the actuator.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplary and schematic block diagram illustrating a configuration of a traveling control device according to an embodiment;

FIG. 2 is an exemplary and schematic diagram illustrating an example of an adjustment coefficient map according to the embodiment;

FIG. 3 is an exemplary and schematic flowchart illustrating a series of processings executed for vehicle stabilization control by the traveling control device according to the embodiment; and

FIG. 4 is an exemplary and schematic diagram illustrating an example of the behavior of a vehicle realized as a result of stabilization control by the traveling control device according to the embodiment.

### DETAILED DESCRIPTION

Hereinafter, embodiments disclosed here will be described with reference to the drawings. Configurations of the embodiments described below and actions and effects provided by the configurations are merely examples and are not limited to the following description.

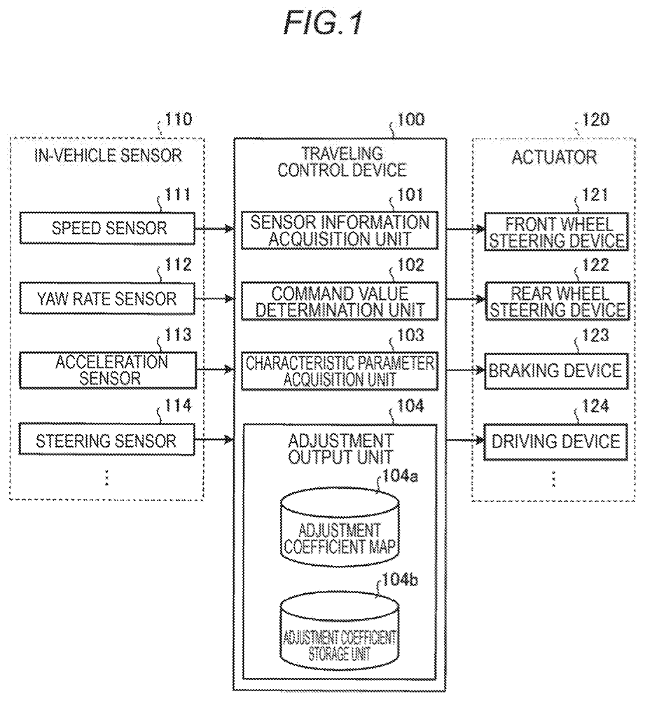

FIG. 1 is an exemplary block diagram illustrating a configuration of a traveling control system including a traveling control device 100 according to an embodiment. The traveling control system is mounted in a vehicle as a system for controlling the traveling state of the vehicle. The vehicle is, for example, a four-wheel vehicle, but a technology of the embodiment may also be applied to general vehicles other than the four-wheel vehicle.

As illustrated in FIG. 1, the traveling control system includes the traveling control device 100 which is in charge of the control of the traveling control system, an in-vehicle sensor 110 which detects information regarding the vehicle, and an actuator 120 which controls the behavior of the vehicle.

The traveling control device 100 is configured as a (micro) computer having hardware such as a processor or a memory. For example, when the behavior of the vehicle is unstable, the traveling control device 100 acquires sensor information as an output value of the in-vehicle sensor 110 and controls the actuator 120 based on the acquired sensor information, thereby executing stabilization control to stabilize the behavior of the vehicle.

Stabilization control is, for example, attitude control that stabilizes the attitude of a vehicle upon traveling when the attitude of the vehicle is unstable. Examples of attitude control may include side slip suppression control that stabilizes the yaw angle of a vehicle so as to suppress a side slip of the vehicle at the time of turning such as understeer or oversteer, or roll and pitch control that stabilizes the roll angle and pitch angle of a vehicle.

Details of the control executed by the traveling control device 100 according to the embodiment will be described later in more detail and thus, a further description thereof is omitted here.

The in-vehicle sensor 110 includes a speed sensor 111 that detects the speed of the vehicle (more specifically, the rotation speed of wheels), a yaw rate sensor 112 that detects a yaw rate generated in the vehicle, an acceleration sensor 113 that detects the longitudinal and transverse accelerations generated in the vehicle, and a steering sensor 114 that detects (the amount of) a steering operation included in a driver's driving operation for the vehicle.

Further, the actuator 120 includes a front wheel steering device 121 that controls the steering angle of a front wheel of the vehicle, a rear wheel steering device 122 that controls the steering angle of a rear wheel of the vehicle, a braking device 123 that controls a brake mechanism which applies a braking force to the vehicle, and a driving device 124 that controls a driving mechanism which applies a driving force to the vehicle.

In the embodiment, the in-vehicle sensor 110 may include, as a sensor that detects information regarding the vehicle, a sensor other than the above-described four sensors illustrated in FIG. 1 so long as it includes at least the yaw rate sensor 112 (and the steering sensor 114). Examples of the other sensor may include an accelerator sensor and a brake sensor that respectively detect (the amount of) an acceleration operation and a braking operation included in a driver's driving operation for the vehicle, or an engine RPM sensor that detects the revolutions per minute of an engine as a vehicle driving mechanism.

Similarly, in the embodiment, the actuator 120 may include a device other than the above-described four devices illustrated in FIG. 1 so long as the device controls the behavior of the vehicle under the control of the traveling control device 100. Examples of the other device may include a steering device that controls the steering of the vehicle, a suspension device that controls the suspension of the vehicle, or a stabilizing device that controls a stabilizer of the vehicle.

By the way, in the related art, studies have been made on a technology to reduce a sense of discomfort given to a driver at the time of execution of stabilization control by suppressing the incompatibility between the behavior of a vehicle that is automatically realized by stabilization control and the behavior of the vehicle that is manually realized by a drivers driving operation. As such a technology, there has been known a technology to correct a target route set as a route on which a vehicle needs to travel according to the drivers intention estimated based on a drivers driving operation and to execute stabilization control along the corrected target route.

However, since the above-described conventional technology is based on the assumption that the vehicle has a configuration for calculating the target route, a vehicle with a simple configuration having no component for calculating the target route is not able to realize the technology.

Therefore, in the embodiment, by giving the functions described below to the traveling control device 100, a reduction in the sense of discomfort given to the driver at the time of execution of stabilization control is realized with a simpler configuration.

That is, the traveling control device 100 according to the embodiment includes, as functions for realizing the above-described effects, a sensor information acquisition unit 101, a command value determination unit 102, a characteristic parameter acquisition unit 103, and an adjustment output unit 104. These functions are realized, for example, as a result of reading and executing a program stored in a memory by a processor of the traveling control device 100. In the embodiment, some or all of the functions of the traveling control device 100 may be realized only by dedicated hardware (circuit).

The sensor information acquisition unit 101 acquires sensor information as an output value of the in-vehicle sensor 110. As described above, the sensor information includes the speed of the vehicle as an output value of the speed sensor 111, the yaw rate of the vehicle as an output value of the yaw rate sensor 112, the longitudinal and transverse accelerations of the vehicle as an output value of the acceleration sensor 113, or the amount of a steering operation of a driver as an output value of the steering sensor 114. In the following description, these output values may be expressed as actual values in the sense of values indicating the actual state of the vehicle.

The command value determination unit 102 determines a command value to be given to the actuator 120 in order to realize stabilization control based on the sensor information acquired by the sensor information acquisition unit 101. For example, the command value determination unit 102 determines a target value of various types of information described above regarding the vehicle to be realized in stabilization control, including a target value of the yaw rate to be generated in the vehicle, based on an actual value of various types of information described above regarding the vehicle obtained as the sensor information including an actual value of the yaw rate of the vehicle, and determines a command value to be given to the actuator 120 such that the difference between the target value and the actual value is reduced.

The characteristic parameter acquisition unit 103 acquires a characteristic parameter indicating the characteristic (feature) of a drivers driving operation of the vehicle as a parameter to be considered in order to suppress the incompatibility between the behavior of the vehicle which is automatically realized by stabilization control and the behavior of the vehicle which is manually realized by a drivers driving operation.

Here, in general, as a technology for estimating the characteristic (feature) of a drivers driving operation, there is known a technology to acquire, as a characteristic parameter, a combination of three parameters τ_{L}′, τₕ′, and h′ which minimize an evaluation function J′ represented by the following equation (4) based on a front gaze model represented by the following equation (3).

$$\begin{matrix}( δ ) ( s ) = \frac{{h}^{′}}{1 + {τ}_{L}^{′} s} \{ ( 1 + {τ}_{h}^{′} s ) y ( s ) - {y}_{OL} ( s ) \} & ( 3 ) \\ {J}^{′} = {\int }_{o}^{T} {[ δ * + {τ}_{L}^{′} \frac{d δ *}{dt} + {h}^{′} ( y * - {y}_{OL} ) + {λ}^{′} \frac{dy *}{dt} ]}^{2} dt & ( 4 )\end{matrix}$$

In the above two equations, 6 is the actual value of the amount of a steering operation for changing the steering angle of the vehicle during a drivers driving operation, y_{OL} is the target value of transverse displacement of the vehicle along the target route of the vehicle, y is the actual value of transverse displacement of the vehicle, τ_{L}′ is the dead time indicating the delay of a drivers response in a driving operation, τₕ′ is the prediction time indicating how far ahead the driver is to perform the driving operation, h′ is a proportionality constant, λ′ is a product of the prediction time and the proportionality constant, and δ* and y* are the actual values of the amount of a steering operation and the actual value of actual transverse displacement of the vehicle as a function of time, respectively.

As can be seen from the above two equations, since the front gaze model is based on the assumption that the difference between a target value and an actual value of transverse displacement of the vehicle may be obtained, it is a technology that may not be realized in a vehicle with a simple configuration having no component for calculating a target route.

However, as described above, an object of the embodiment is to provide a technology that may be realized in a vehicle with a simple configuration having no component for calculating a target route.

Therefore, the present inventors have found, as a result of earnest examination based on experiments, that an appropriate characteristic parameter equivalent to a characteristic parameter obtained by the front gaze model may be acquired even by a model that replaces the transverse displacement of the vehicle in the front gaze model with the yaw rate of the vehicle.

That is, in the embodiment, the characteristic parameter acquisition unit 103 acquires, as a characteristic parameter, a combination of three parameters τ_{L}, τₕ, and h which minimize the value of an evaluation function J represented by the following equation (6) based on a model represented by the following equation (5) as an analogy of the front gaze model. The acquisition of the characteristic parameter is repeatedly (periodically) executed at a predetermined control cycle while stabilization control is being executed.

$$\begin{matrix}δ ( s ) = - \frac{h}{1 + {τ}_{L} s} \{ ( 1 + {τ}_{h} s ) ϒ ( s ) - {ϒ}_{OL} ( s ) \} & ( 5 ) \\ J = {\int }_{o}^{T} {[ {δ}^{*} + {τ}_{L} \frac{d {δ}^{*}}{dt} + h ( {γ}^{*} - {γ}_{OL} ) + λ \frac{d {γ}^{*}}{dt} ]}^{2} dt & ( 6 )\end{matrix}$$

In the above two equations, δ is the actual value of the amount of a drivers steering operation, γ is the actual value of the yaw rate, γ_{OL} is the target value of the yaw rate, τ_{L} is the dead time indicating the delay of a drivers response in a driving operation, τₕ is the prediction time indicating how far ahead the driver is to perform the driving operation, h is a proportionality constant, λ is a product of the prediction time and the proportionality constant, and δ* and γ* are the actual values of the amount of a steering operation and the actual value of the yaw rate as a function of time, respectively.

The above equation (5) corresponds to a transfer function of a first-order lag system and thus, is conceivable to be particularly significant in a section where γ changes to approach (converge on) y_{OL} due to the characteristic thereof. Thus, in the embodiment, the characteristic parameter acquisition unit 103 acquires, as a characteristic parameter, a combination of three parameters τ_{L}, τₕ, and h which minimize the value of the above evaluation function J in the section where the actual value of the yaw rate changes so as to approach the target value. As described later, in the embodiment, basically, a characteristic parameter is used for control only when a change in the repeatedly acquired characteristic parameter converges within a predetermined range and the characteristic parameter is (substantially) determined.

By the way, the characteristic parameter may be converted as a parameter indicating the skill level of a drivers driving operation by a predetermined calculation using a map determined based on experiments. In general, it is conceivable that a driver with a low skill level may not easily feel a sense of discomfort even if the behavior of the vehicle which is automatically realized by stabilization control increases and that a driver with a high skill level may easily feel a sense of discomfort due to the difference with the behavior of the vehicle which is manually realized by a driving operation when the behavior of the vehicle which is automatically realized by stabilization control increases.

Therefore, in the embodiment, the adjustment output unit 104 adjusts the command value determined by the command value determination unit 102 according to the characteristic parameter acquired by the characteristic parameter acquisition unit 103 such that the driving amount of the actuator 120 is reduced as a drivers driving operation is more skilled, and outputs the adjusted command value to the actuator 120.

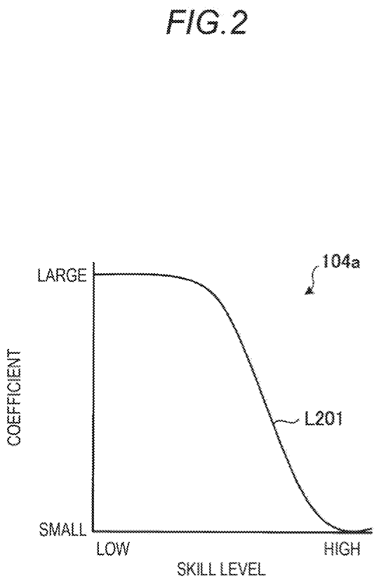

More specifically, the adjustment output unit 104 has an adjustment coefficient map 104a as illustrated in FIG. 2 illustrating a correspondence between the skill level of a drivers driving operation and an adjustment coefficient by which the command value is multiplied.

FIG. 2 is an exemplary and schematic diagram illustrating an example of the adjustment coefficient map 104a according to the embodiment. In FIG. 2, the horizontal axis represents the skill level of a drivers driving operation, and the vertical axis represents an adjustment coefficient by which the command value is multiplied.

As illustrated in FIG. 2, the adjustment coefficient map 104a is set such that the coefficient is smaller as the skill level of a driver's driving operation is higher and such that the coefficient is larger as the skill level of a driver's driving operation is lower (see solid line L201). Thus, the adjustment of the command value may be executed according to the skill level of a driver's driving operation, and the adjusted command value may be given to the actuator 120, so as to reduce a sense of discomfort given to the driver at the time of execution of stabilization control.

That is, in the embodiment, the adjustment output unit 104 first determines the skill level of the driver by a predetermined calculation according to the characteristic parameter acquired by the characteristic parameter acquisition unit 103. Then, the adjustment output unit 104 determines a coefficient by which the command value determined by the command value determination unit 102 is multiplied by referring to the adjustment coefficient map 104a using the skill level of the driver as an argument. Then, the adjustment output unit 104 adjusts the command value by multiplying the command value by the coefficient, and outputs the adjusted command value to the actuator 120.

As can be seen from the above equations (5) and (6), the characteristic parameter changes in nature to converge as time passes. Further, since the characteristic parameter is a parameter indicating the characteristic of a driver's driving operation, and is basically a unique value for each driver, the characteristic parameter does not substantially change unless a change of drivers occurs.

Thus, returning again to FIG. 1, in the embodiment, the adjustment output unit 104 includes an adjustment coefficient storage unit 104b as a memory in which an adjustment coefficient for the command value determined by the command value determination unit 102 is stored. A predetermined coefficient (initial value) is stored in the adjustment coefficient storage unit 104b, for example, in an initial state before stabilization control is initiated.

In the embodiment, the adjustment output unit 104 acquires an adjustment coefficient based on the adjustment coefficient map 104a when a change in the characteristic parameter substantially converges and the characteristic parameter is determined after stabilization control is initiated, updates the initial value stored in the adjustment coefficient storage unit 104b with the acquired coefficient, and adjusts the command value based on the updated coefficient. Then, once the adjustment coefficient has been updated, the adjustment output unit 104 adjusts the command value using the adjustment coefficient acquired last time, that is, the adjustment coefficient stored in the adjustment coefficient storage unit 104b without referring to the adjustment coefficient map 104a again. Thus, it is possible to suppress a processing using the adjustment coefficient map 104a from being repeatedly executed even after it may be considered that it is unnecessary to acquire a new adjustment coefficient since the characteristic parameter is determined, which may reduce a processing burden.

Meanwhile, in the embodiment, the adjustment output unit 104 adjusts the command value based on the initial value stored in the adjustment coefficient storage unit 104b without referring to the adjustment coefficient map 104a when a change in the characteristic parameter does not converge and the characteristic parameter is not determined even after stabilization control is initiated. Thus, it is possible to suppress the execution of incorrect adjustment based on undetermined characteristic parameters.

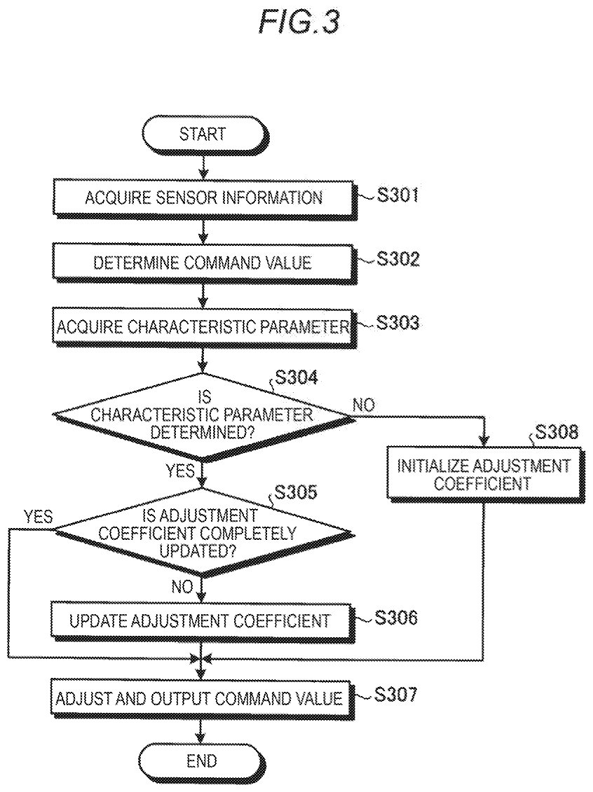

Based on the above configuration, the traveling control device 100 according to the embodiment executes a processing according to the flowchart as illustrated in FIG. 3 below.

FIG. 3 is an exemplary and schematic flowchart illustrating a series of processings executed for vehicle stabilization control by the traveling control device 100 according to the embodiment. The series of processings illustrated in FIG. 3 are repeatedly (periodically) executed at a predetermined control cycle.

As illustrated in FIG. 3, in the embodiment, first, in step S301, the sensor information acquisition unit 101 of the traveling control device 100 acquires sensor information as an output value of the in-vehicle sensor 110.

Then, in step S302, the command value determination unit 102 of the traveling control device 100 determines a command value to be given to the actuator 120 in order to realize stabilization control based on the sensor information acquired in step S301. More specifically, the command value determination unit 102 determines a target value of various types of information regarding the vehicle to be realized in stabilization control based on an actual value of various types of information regarding the vehicle obtained as the sensor information, and determines a command value to be given to the actuator 120 such that the difference between the target value and the actual value is reduced.

Then, in step S303, the characteristic parameter acquisition unit 103 of the traveling control device 100 acquires a characteristic parameter indicating the characteristic of a drivers driving operation with the above-described equations (5) and (6) based on the actual value of various types of information regarding the vehicle obtained in step S301 and the target value of various types of information regarding the vehicle obtained in step S302. The above equations (5) and (6) particularly require the amount of a driver's steering operation δ, the actual value of the yaw rate γ, and the target value of the yaw rate γ*.

Then, in step S304, the adjustment output unit 104 of the traveling control device 100 determines whether or not a change in the characteristic parameter acquired in step S303 has substantially converged and the characteristic parameter has been determined.

When it is determined in step S304 that the characteristic parameter has been determined, the processing proceeds to step S305. Then, in step S305, the adjustment output unit 104 of the traveling control device 100 determines whether or not an adjustment coefficient (of the command value) stored in the adjustment coefficient storage unit 104b has already been completely updated by the coefficient acquired based on the adjustment coefficient map 104a.

When it is determined in step S305 that the adjustment coefficient has not been updated, the processing proceeds to step S306. Then, in step S306, the adjustment output unit 104 of the traveling control device 100 acquires the skill level of a driver's driving operation based on the characteristic parameter acquired in step S303, acquires an adjustment coefficient by referring to the adjustment coefficient map 104a using the skill level as an argument, and updates the adjustment coefficient stored in the adjustment coefficient storage unit 104b based on the acquired coefficient.

Then, in step S307, the adjustment output unit 104 of the traveling control device 100 adjusts the command value by multiplying the command value by the adjustment coefficient updated in step S305, and outputs the adjusted command value to the actuator 120. Then, the processing ends.

When it is determined in step S305 that the adjustment coefficient has been completely updated, step S306 is omitted, and the processing proceeds to step S307. Then, in step S307, the adjustment output unit 104 of the traveling control device 100 adjusts the command value by multiplying the command value by the adjustment coefficient stored in the adjustment coefficient storage unit 104b, that is, the adjustment coefficient used in the last adjustment, and outputs the adjusted command value to the actuator 120. Then, the processing ends.

Meanwhile, when it is determined in step S304 that the characteristic parameter has not been determined, the processing proceeds to step S308 rather than proceeding to step S305. Then, in step S308, the adjustment output unit 104 of the traveling control device 100 initializes the adjustment coefficient stored in the adjustment coefficient storage unit 104b to, for example, a predetermined coefficient (initial value) corresponding to the initial state before stabilization control is initiated.

When the processing of step S308 ends, the processing proceeds to step S307. Then, in step S307, the adjustment output unit 104 of the traveling control device 100 adjusts the command value using the initial value stored in adjustment coefficient storage unit 104b, and outputs the adjusted command value to actuator 120. Then, the processing ends.

With the stabilization control according to the embodiment based on the configuration and processing described above, the behavior of the vehicle to be described below may be obtained.

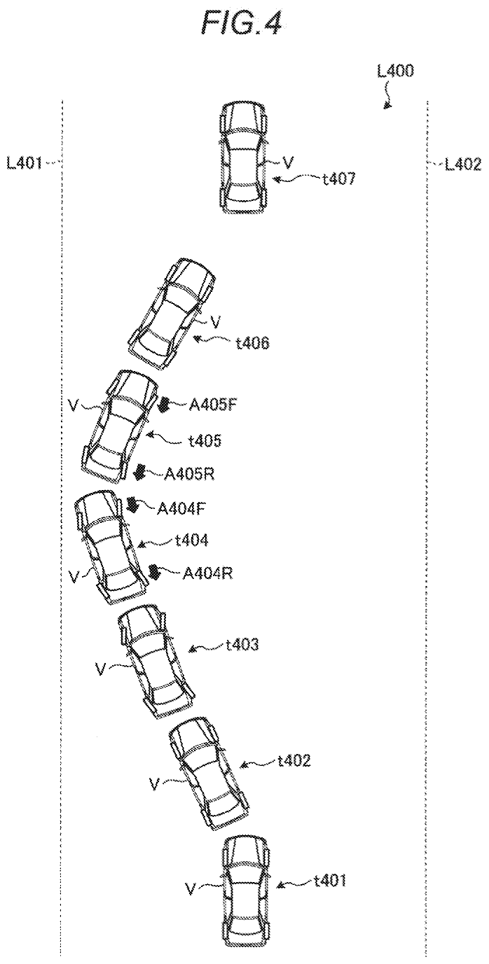

FIG. 4 is an exemplary and schematic diagram illustrating an example of the behavior of the vehicle realized as a result of stabilization control by the traveling control device 100 according to the embodiment. The example illustrated in FIG. 4 indicates, at multiple timings t401 to t407, a series of behaviors of the vehicle V realized when stabilization control (side slip suppression control) according to the embodiment is executed for a situation in which understeer occurs in a vehicle V that is traveling along a lane L400.

In the example illustrated in FIG. 4, at the timing t401, the vehicle V travels straight along the lane L400. However, in the example illustrated in FIG. 4, from the timing t401 to the timing t402, the yaw angle of the vehicle V increases due to a factor such as a low μ road on which the vehicle V is traveling, so that a sign of the vehicle V deviating from the lane L400 is appearing. Thus, in the example illustrated in FIG. 4, at the timing t403, as a result of a driver's steering operation, the front wheels and rear wheels of the vehicle V are steered in the direction in which the deviation from the lane L400 is eliminated (the right turn direction in FIG. 4).

However, in the example illustrated in FIG. 4, understeer occurs due to the steering of the front wheels and rear wheels at the timing t403, so that the turning trajectory of the vehicle V expands, and the traveling attitude of the vehicle V becomes unstable. Thus, in the example illustrated in FIG. 4, from the timing t404 to the timing t405, side slip suppression control as stabilization control is executed, so that a braking force is applied to the front wheels and rear wheels located inside the turning trajectory, in addition to the steering of the front wheels and rear wheels. As a result, in the example illustrated in FIG. 4, both the elimination of the deviation from the lane L400 and the stabilization of the traveling attitude may be achieved, and at the timing t407 after the timing t406, the vehicle V may obtain the state similar to that at the timing t401 at which the vehicle V travels straight between lane marks L401 and L402.

In the embodiment, based on the above-described configuration and processing, for example, the magnitude of the braking force generated according to the side slip suppression control (see arrows A404F, A404R, A405F, and A405R) is adjusted according to the skill level of a driver's driving operation. Thus, it is possible to execute side slip suppression control at a level that does not give a sense of discomfort to the driver according to the skill level of the driver.

As described above, the traveling control device 100 according to the embodiment includes the sensor information acquisition unit 101, the command value determination unit 102, the characteristic parameter acquisition unit 103, and the adjustment output unit 104. The sensor information acquisition unit 101 acquires an output value of the in-vehicle sensor 110 which detects information regarding the vehicle, the in-vehicle sensor 110 including at least the yaw rate sensor 112 which detects an actual value of the yaw rate generated in the vehicle. The command value determination unit 102 determines a target value of at least the yaw rate to be generated in the vehicle based on the output value of the in-vehicle sensor 110, and determines a command value to be given to the actuator 120 which controls the behavior of the vehicle such that the difference between the actual value and the target value of at least the yaw rate is reduced. The characteristic parameter acquisition unit 103 acquires a characteristic parameter indicating the characteristic of a drivers driving operation of the vehicle based on the difference between the actual value and the target value of at least the yaw rate. The adjustment output unit 104 adjusts the command value according to the characteristic parameter, and outputs the adjusted command value to the actuator 120.

According to the traveling control device 100 described above, for example, even if there is no component for calculating a target route, a command value for stabilizing the behavior of the vehicle based on the difference between the actual value and the target value of at least the yaw rate by reducing the difference may be adjusted according to the characteristic of a driver's driving operation and be given to the actuator 120. Thus, a reduction in the sense of discomfort given to the driver at the time of execution of stabilization control may be realized with a simpler configuration.

More specifically, in the embodiment, the sensor information acquisition unit 101 acquires an output value of the in-vehicle sensor 110 including the steering sensor 114 which detects the amount of a steering operation for changing the steering angle of the vehicle during a driver's driving operation in addition to at least the yaw rate sensor 112. Then, the characteristic parameter acquisition unit 103 acquires, as a characteristic parameter, a combination of three parameters τ_{L}, τₕ, and h which minimize the value of an evaluation function J represented by the above equation (6) based on a model represented by the above equation (5). According to this configuration, an appropriate characteristic parameter may be easily acquired based on equations.

More specifically, in the embodiment, the characteristic parameter acquisition unit 103 acquires, as a characteristic parameter, the combination of the three parameters τ_{L}, τₕ, and h which minimize the value of the evaluation function J represented by the above equation (6) in a section where the actual value of the yaw rate changes to approach the target value. According to this configuration, the characteristic parameter may be accurately acquired according to the property of the above equation that a calculation result is particularly significant in the section where the actual value of the yaw rate changes to approach the target value.

In the embodiment, the adjustment output unit 104 adjusts the command value according to the characteristic parameter such that the driving amount of the actuator 120 is reduced as a driver's driving operation is more skilled. According to this configuration, the sense of discomfort given to the driver at the time of execution of stabilization control may be appropriately reduced according to the skill level of a driver's driving operation.

A traveling control device as an example according to an aspect of this disclosure includes a sensor information acquisition unit configured to acquire an output value of an in-vehicle sensor that detects information regarding a vehicle and includes at least a yaw rate sensor that detects an actual value of a yaw rate generated in the vehicle, a command value determination unit configured to determine a target value of at least the yaw rate to be generated in the vehicle based on the output value of the in-vehicle sensor and determine a command value to be given to an actuator that controls a behavior of the vehicle such that a difference between the actual value and the target value of at least the yaw rate is reduced, a characteristic parameter acquisition unit configured to acquire a characteristic parameter indicating a characteristic of a driver's driving operation of the vehicle based on the difference between the actual value and the target value of at least the yaw rate, and an adjustment output unit configured to adjust the command value according to the characteristic parameter and output the adjusted command value to the actuator.

According to the traveling control device described above, even if there is no component for calculating a target route, based on the difference between the actual value and the target value of at least the yaw rate, a command value for stabilizing the behavior of the vehicle by reducing the difference may be adjusted according to the characteristic of a driver's driving operation and be given to the actuator. Thus, a reduction in the sense of discomfort given to a driver at the time of execution of stabilization control may be realized with a simpler configuration.

In the traveling control device, the sensor information acquisition unit may acquire an output value of the in-vehicle sensor including a steering sensor that detects an amount of a steering operation for changing a steering angle of the vehicle among the driver's driving operation in addition to at least the yaw rate sensor, and the characteristic parameter acquisition unit may acquire, as the characteristic parameter, a combination of three parameters τ_{L}, τₕ, and h that minimize a value of an evaluation function J represented by the following equation (2) based on a model represented by the following equation (1). According to this configuration, an appropriate characteristic parameter may be easily acquired based on equations.

$$\begin{matrix}δ ( s ) = - \frac{h}{1 + {τ}_{L} s} \{ ( 1 + {τ}_{h} s ) ϒ ( s ) - {ϒ}_{OL} ( s ) \} & ( 1 ) \\ J = {\int }_{o}^{T} {[ {δ}^{*} + {τ}_{L} \frac{d {δ}^{*}}{dt} + h ( {γ}^{*} - {γ}_{OL} ) + λ \frac{d {γ}^{*}}{dt} ]}^{2} dt & ( 2 )\end{matrix}$$

Here, δ is an actual value of the amount of the driver's steering operation, γ is the actual value of the yaw rate, γ_{OL} is the target value of the yaw rate, τ_{L} is a dead time indicating a delay of a drivers response in the driving operation, τₕ is a prediction time indicating how far ahead a driver is to perform the driving operation, h is a proportionality constant, λ is a product of the prediction time and the proportionality constant, and δ* and γy* are actual values of the amount of the steering operation and the actual value of the yaw rate as a function of time, respectively.

In this case, the characteristic parameter acquisition unit may be configured to acquire, as the characteristic parameter, the combination of the three parameters τ_{L}, τₕ, and h that minimize the value of the evaluation function J in a section where the actual value of the yaw rate changes to approach the target value. According to this configuration, the characteristic parameter may be accurately acquired according to the property of the above equation that a calculation result is particularly significant in the section where the actual value of the yaw rate changes to approach the target value.

Further, in the traveling control device, the adjustment output unit may adjust the command value according to the characteristic parameter such that a driving amount of the actuator is reduced as the drivers driving operation is more skilled. According to this configuration, the sense of discomfort given to the driver at the time of execution of stabilization control may be appropriately reduced according to the skill level of a driver's driving operation.

Although the embodiment disclosed here has been described above, the above-described embodiment is merely given by way of example, and is not intended to limit the scope of the disclosure. The new embodiment described above may be implemented in various forms, and various omissions, replacements, or changes may be made without departing from the gist of the disclosure. Further, the above-described embodiment and modifications thereof are included in the scope or the gist of the disclosure, and are also included in the range equivalent to the disclosure described in the claims.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A traveling control device comprising:
a sensor information acquisition unit configured to acquire an output value of an in-vehicle sensor that detects information regarding a vehicle and includes at least a yaw rate sensor that detects an actual value of a yaw rate generated in the vehicle;
a command value determination unit configured to determine a target value of at least the yaw rate to be generated in the vehicle based on the output value of the in-vehicle sensor and determine a command value to be given to an actuator that controls a behavior of the vehicle such that a difference between the actual value and the target value of at least the yaw rate is reduced;
a characteristic parameter acquisition unit configured to acquire a characteristic parameter indicating a characteristic of a driver's driving operation of the vehicle based on the difference between the actual value and the target value of at least the yaw rate; and
an adjustment output unit configured to adjust the command value according to the characteristic parameter and output the adjusted command value to the actuator.

2. The traveling control device according to claim 1, wherein
the sensor information acquisition unit acquires an output value of the in-vehicle sensor including a steering sensor that detects an amount of a steering operation for changing a steering angle of the vehicle among the driver's driving operation in addition to at least the yaw rate sensor, and
the characteristic parameter acquisition unit acquires, as the characteristic parameter, a combination of three parameters τ_{L}, τₕ, and h that minimize a value of an evaluation function J represented by the following equation (2) based on a model represented by the following equation (1):
$$\begin{matrix}δ ( s ) = - \frac{h}{1 + {τ}_{L} s} \{ ( 1 + {τ}_{h} s ) ϒ ( s ) - {ϒ}_{OL} ( s ) \} & ( 1 ) \\ J = {\int }_{o}^{T} {[ {δ}^{*} + {τ}_{L} \frac{d {δ}^{*}}{dt} + h ( {γ}^{*} - {γ}_{OL} ) + λ \frac{d {γ}^{*}}{dt} ]}^{2} dt & ( 2 )\end{matrix}$$
here, δ is an actual value of the amount of the driver's steering operation, γ is the actual value of the yaw rate, γ_{OL} is the target value of the yaw rate, τ_{L} is a dead time indicating a delay of a drivers response in the driving operation, τₕ is a prediction time indicating how far ahead a driver is to perform the driving operation, h is a proportionality constant, λ is a product of the prediction time and the proportionality constant, and δ* and γ* are actual values of the amount of the steering operation and the actual value of the yaw rate as a function of time, respectively.

3. The traveling control device according to claim 2, wherein
the characteristic parameter acquisition unit is configured to acquire, as the characteristic parameter, the combination of the three parameters 96 _{L}, τₕ, and h that minimize the value of the evaluation function J in a section where the actual value of the yaw rate changes to approach the target value.

4. The traveling control device according to claim 1, wherein
the adjustment output unit adjusts the command value according to the characteristic parameter such that a driving amount of the actuator is reduced as the drivers driving operation is more skilled.
